(19) United States
(12) Patent Application Publication
(10) Pub. No.: US 2013/0329060 A1
(43) Pub. Date: Dec. 12, 2013

(54) OVERLAY IMAGE PROVIDING SYSTEM, SERVER AND METHOD

(71) Applicant: Hang Wah Yim, Shatin (HK)

(72) Inventor: Hang Wah Yim, Shatin (HK)

(21) Appl. No.: 13/909,205

(22) Filed: Jun. 4, 2013

(30) Foreign Application Priority Data
Jun. 12, 2012 (CN) 201210193805.3

(51) Int. Cl. G06F 17/30; G06T 11/60; H04N 5/262

(52) U.S. Cl. CPC G06F 17/30244; H04N 5/2621; G06T 11/60
USPC 348/207.1; 382/305

(57) ABSTRACT

An overlay image providing system, server and method is disclosed. The method comprises an overlay image providing server receiving download request information for an overlay image transmitted by a download device and returning a corresponding overlay image to the download device according to the download request information for an overlay image, wherein the overlay image is uploaded beforehand by an upload device to the overlay image providing server via the network. Since the overlay image providing server can provide an overlay image to be directly downloaded by an image pickup device, the process of the image pickup device acquiring the overlay image and superimposing the overlay image onto the field of view of camera is greatly simplified. Other users can also upload overlay images to the overlay image providing server via the upload.

### CROSS-REFERENCE TO RELATED APPLICATIONS

The application claims priority to Chinese Patent Application No. 201210193805.3, titled as “Overlay Image Providing System, Server and Method” filed on Jun. 12, 2012, which is herein incorporated in its entirety by reference.

### TECHNICAL FIELD

The invention relates to the computer communication technology, and in particular relates to an overlay image providing system, server and method.

### BACKGROUND

With a continuous development of the computer image processing technique, the image processing technique of overlaying one image on the other image can be achieved in an electronic computer system or device with a graphical display. Generally, a main image is overlaid by an overlay image, and the overlay image can be a specific geometrical figure or any image to thereby achieve an image composition effect. For example, by overlaying a frame overlay image on a main image, a composite image having a frame effect can be generated. The pixel in the overlay image can be defined as a transparent or non-transparent one. For example, it is permitted to define a specific color in the overlay image to a transparent one and define the other colors as non-transparent ones.

At present, the above image overlaying technique is also applied to an image pickup device. The image pickup device can be specifically a digital camera, a digital video recorder, a mobile phone having a photographing function, a digital recorder, a digital photo album, etc. Taking the digital camera as an example, before the digital camera performs the image photographing, the user can select one overlay image from the storage, superimpose the overlay image onto the field of view of camera of the digital camera, or the fields of view of camera of a video camera, a digital video recorder, a mobile phone having a photographing function, a digital recorder, a digital photo album, a TV, etc., and can perform adjusting operations such as color change, position change, adjustment of the horizontal or vertical size, rotation and the like with respect to the overlay image, i.e., performing the image photographing after adjusting the overlay image to a proper position and size in the field of view of camera of the digital camera to thereby compose the image of the photographed scene and the overlay image in the image obtained by photographing. The field of view of camera generally refers to a lens frame of a digital camera, a video camera, a digital video recorder, a mobile phone having a photographing function, a digital recorder, a digital photo album, etc. for photographing and shooting scenery, and the frame is generally a rectangular frame having an aspect ratio.

However, in the prior art, the process of the image pickup device acquiring the overlay image and superimposing the overlay image onto the field of view of camera is generally comparatively complicated, and is not conveniently achieved by a user, i.e., the user generally needs to firstly seek for a cutout containing the desired image, e.g., if the desired image is an apple, firstly seeking for a cutout containing the apple; then, the user uses an image editing software to perform operations such as trimming, removing irrelevant pixels, transparent processing, etc., and after making the overlay image suitable to be superimposed onto the field of view of camera of the image pickup device, transmits the made overlay image to the image pickup device using a specific software and then superimposes it onto the field of view of camera. As can be seen, in the prior art, it is not convenient to acquire the overlay image suitable to be superimposed onto the field of view of camera of the image pickup device, and a method capable of providing convenience for acquiring an overlay image is absent.

### SUMMARY

The embodiments of the invention provide an image providing system, server and method and an image pickup device for providing an overlay image to be superimposed onto the field of view of camera for the image pickup device more conveniently.

According to one aspect of the invention, an overlay image providing method is provided, the method comprising:

an overlay image providing server receiving download request information for an overlay image transmitted by a download device;

the overlay image providing server returning a corresponding overlay image to the download device according to the download request information for an overlay image,

wherein the overlay image is uploaded beforehand by an upload device to the overlay image providing server via the network.

Wherein, after the overlay image providing server returns the corresponding overlay image to the download device according to the download request information for an overlay image, the method further comprising:

after receiving the returned overlay image, the download device superimposing the overlay image on other images to perform editing to obtain an edited image with a composition effect; or

the download device being specifically an image pickup device, and after receiving the returned overlay image, the image pickup device performing photographing after superimposing the overlay image onto the field of view of camera to obtain an photographed image with a composition effect.

Wherein, before the upload device uploads the overlay image to the overlay image providing server via the network, the method further comprising:

the upload device editing the overlay image via a built-in image editing tool, i.e., setting a pixel of a specific color in the overlay image to a transparent pixel, or removing a pixel in a specific region in the overlay image or setting it to a transparent one.

Wherein, when the upload device uploads the overlay image to the overlay image providing server via the network, the method further comprising:

the upload device further uploading edit information of the overlay image to the overlay image providing server via the network;

after receiving the overlay image and the edit information thereof, the overlay image providing server editing the overlay image according to the edit information, i.e., setting a pixel of a specific color in the overlay image to a transparent pixel, or removing a pixel in a specific region in the overlay image or setting it to a transparent one.

Wherein, before the upload device uploads the overlay image to the overlay image providing server via the network, the method further comprising:

the upload device recording an editing behavior of the overlay image by the user and saving it in an editing behavior list; and uploading the editing behavior saved in the editing behavior list to the overlay image providing server; and

after the upload device uploads the overlay image to the overlay image providing server via the network, further comprising:

the overlay image providing server editing and modifying the overlay image according to the editing behavior in the editing behavior list uploaded by the upload device; and saving the edited and modified overlay image, and returning a link download address of the modified overlay image to the upload device.

Wherein, the method further comprising: when uploading the overlay image to the overlay image providing server via the network, the upload device further uploading related information of the overlay image to the overlay image providing server, the related information of the overlay image including: a name, a label and a category of the overlay image.

Wherein, before the overlay image providing sever receives the download request information for an overlay image, the method further comprising

the overlay image providing server receiving a query condition transmitted by the download device, finding out the overlay image meeting the query condition according to the related information of the respective overlay images, and presenting a thumbview corresponding to the overlay image meeting the query condition in an overlay image page view transmitted to the download device.

Wherein, before the overlay image providing server receives the query condition transmitted by the download device, the method further comprising:

the overlay image providing server recommending an overlay image to be displayed to a user in the overlay image page view, and the overlay image recommended to be displayed being preferentially recommended according to an analysis result after the overlay image providing server collects and counts past searching and browsing behaviors of the user or searching and browsing behaviors of a user similar to this user to perform an analysis;

or the overlay image providing server recommending an overlay image to be displayed to a user in the overlay image page view, and the overlay image recommended to be displayed being preferentially recommended according to an ordering result after the overlay image providing server orders frequencies by which the respective overlay images are accessed, or orders times by which the respective images are accessed, or numbers of times by which the respective overlay images are accessed.

Wherein, after the upload device uploads the overlay image and the related information thereof to the overlay image providing server via the network, the method further comprising:

the overlay image providing server storing an image file of the overlay image in an image storage server, and correspondingly storing the related information of the overlay image and the storage address of the overlay image in the overlay image storage server in a database; the overlay image providing server generating a thumbview corresponding to the overlay image according to the overlay image, and correspondingly storing the thumbview and the storage address of the related information of the overlay image in the database;

the overlay image providing server further storing the storage address of the thumbview in the database, and associating it with the related information of the overlay image.

Wherein, the finding out the overlay image meeting the query condition according to the related information of the respective overlay images, and presenting a thumbview corresponding to the overlay image meeting the query condition in an overlay image page view transmitted to the download device being specifically as follows:

finding out the overlay image whose related information meets the query condition in the related information of the respective overlay images stored in the database;

fetching the thumbview to present it in the overlay image page view transmitted to the download device according to the storage address of the thumbview associated with the related information of the overlay image meeting the query condition.

Wherein, the overlay image providing server returning a corresponding overlay image to the download device according to the download request information for an overlay image specifically comprising:

the overlay image providing server determining the thumbview selected by the download device according to the download request information for an overlay image;

determining the related information of the overlay image corresponding to the thumbview and the storage address of the overlay image stored corresponding to the related information of the overlay image in the overlay image storage server according to the storage address of the related information of the overlay image corresponding to the thumbview in the database;

fetching the overlay image and returning the overlay image to the download device according to the storage address of the determined overlay image in the overlay image storage server.

Wherein, when receiving the query condition transmitted by the download device, the overlay image providing server further receives an ordering condition transmitted by the download device; and

before presenting the thumbview corresponding to the overlay image meeting the query condition in the overlay image page view transmitted to the download device as a query result, the method further comprises:

ordering the query results according to the ordering condition.

Wherein, before the overlay image providing server receives the download request information for an overlay image transmitted by the download device, and the overlay image providing server returns the corresponding overlay image to the download device according to the download request information for an overlay image, the method further comprising:

the overlay image being converted from a common image, i.e., in an overlay image conversion page provided by the overlay image providing server, a user inputs a website or uses other search engines to open a common image from the internet, and identifies it as an image to be converted, and after inviting other users to cast a vote therefor, the overlay image providing server converts the image to be converted for which the votes exceed a set value into an overlay image.

According to another aspect of the invention, an overlay image providing server is provided, the overlay image providing server comprising:

an overlay image download module for receiving download request information for an overlay image transmitted by a download device; and returning a corresponding overlay image to the download device according to the download request information for an overlay image;

an overlay image upload module for receiving the overlay image uploaded by an upload device via the network and performing storage.

Wherein, the overlay image upload module is further used for further receiving related information of the overlay image uploaded by the upload device when receiving the overlay image uploaded by the upload device via the network, the related information of the overlay image including: a name, a label and a category of the overlay image.

Wherein, the overlay image upload module is further used for further receiving edit information of the overlay image when receiving the overlay image; and the server further comprises:

an image editing module for editing the overlay image according to the edit information of the overlay image, i.e., setting a pixel of a specific color in the overlay image to a transparent pixel, or removing a pixel in a specific region in the overlay image or setting it to a transparent one; and transmitting the edited overlay image to the overlay image upload module; and

the overlay image upload module specifically stores the edited overlay image.

Wherein, the overlay image download module is further used for receiving a query condition transmitted by the download device, finding out the overlay image meeting the query condition according to the related information of the respective overlay images, and presenting a thumbview corresponding to the overlay image meeting the query condition in an overlay image page view transmitted to the download device before receiving the download request information for an overlay image.

Wherein, the overlay image upload module is further used for storing an image file of the overlay image in an image storage server, and correspondingly storing the related information of the overlay image and the storage address of the overlay image in the overlay image storage server in a database; and generating a thumbview corresponding to the overlay image according to the overlay image, and correspondingly storing the thumbview and the storage address of the related information of the overlay image in the database after receiving the overlay image and the related information thereof uploaded by the upload device via the network.

Wherein, the overlay image download module finding out the overlay image meeting the query condition according to the related information of the respective overlay images, and presenting a thumbview corresponding to the overlay image meeting the query condition in an overlay image page view transmitted to the download device is specifically as follows:

the overlay image download module finds out the overlay image whose related information meets the query condition in the related information of the respective overlay images stored in the database; and fetches the thumbview to present it in the overlay image page view transmitted to the download device according to storage address of the thumbview associated with the related information of the overlay image meeting the query condition.

In the embodiments of the invention, since the overlay image providing server can provide an overlay image to be directly downloaded by an image pickup device, the image pickup device can directly acquire the overlay image via the overlay image providing server before superimposing the overlay image onto the field of view of camera, and seeking, processing and editing of the overlay image are omitted, which greatly simplifies the process of the image pickup device acquiring the overlay image and superimposing the overlay image onto the field of view of camera, and provides great convenience for a user. And, other users can also upload overlay images to the overlay image providing server via the upload device to provide more overlay images for the overlay image providing server to thereby achieve sharing of the overlay images.

In addition, the overlay image providing server can also provide an editing function of the overlay image, and when the upload device uploads the overlay image, the overlay image providing server can also provide an editing service of the overlay image to further facilitate the sharing of the overlay image.

### BRIEF DESCRIPTION OF THE DRAWINGS

FIG. 1 is a schematic diagram of the overlay image providing system of the embodiment of the invention;

FIG. 2 is a flow chart of the overlay image uploading method of the embodiment of the invention;

FIG. 3 is a flow chart of the overlay image downloading method of the embodiment of the invention;

FIG. 4 is a block diagram of the internal structure of the overlay imaging providing server of the embodiment of the invention;

FIG. 5 is a block diagram of the internal structure of the image pickup device of the embodiment of the invention; and

FIG. 6 is a flow chart of the method of performing the editing operation of the overlay image by a local client and performing editing and modification of the overlay image by the overlay image providing server of the embodiment of the invention.

### DETAILED DESCRIPTION

In order to make the object, the technical solution and the advantages of the invention clearer, further detailed descriptions of the invention are given below by referring to the figures and listing preferred embodiments. However, it should be noted that many details listed in the Description only aim to make the readers thoroughly understand one or more aspects of the invention, and these aspects of the invention can be also achieved even if these specific details are absent.

The terms such as “module” and “system” used in the present application aim to include entities associated with the computer, for example but not limited to hardware, firmware, combination of software and hardware, software or software in execution. For example, the module can be, but not limited to: a process running on a processor, a processor, an object, an executable program, an executed thread, a program and/or a computer. For example, an application program running on a computer device and the computer device can be both modules. One or more modules can be located within one process and/or thread in execution, and one module can be also located on one computer and/or distributed between two or more computers.

In the technical solutions provided in the invention, an overlay image providing server is adopted to provide functions of upload, storage, download, classification and sharing, so the image pickup device can directly acquire the overlay image from the overlay image providing server with seeking, processing and editing of the overlay image omitted, which greatly simplifies the process of the image pickup device acquiring the overlay image and superimposing the overlay image onto the field of view of camera, and provides great convenience for a user.

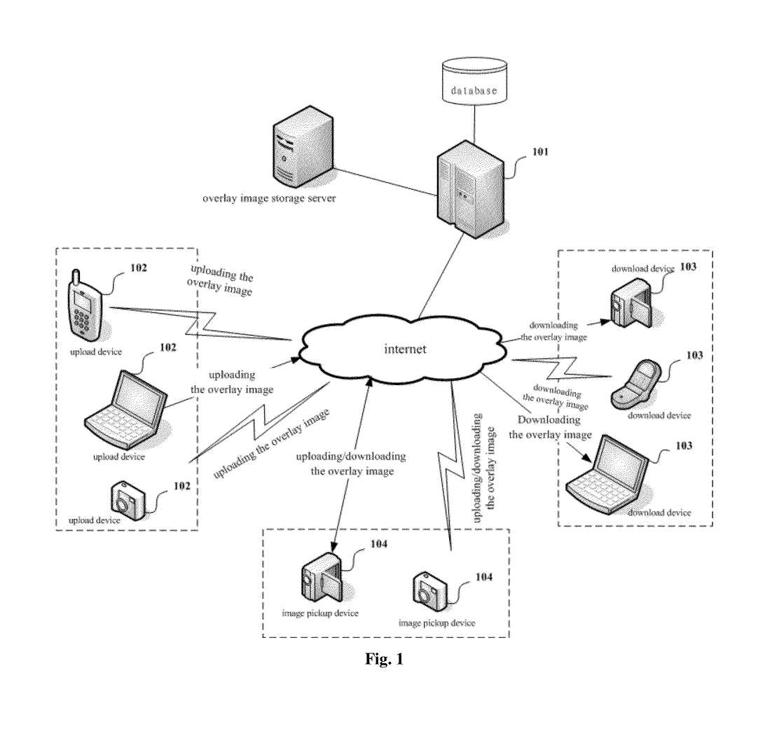

The technical solutions of the embodiments of the invention are described in detail below by taking the figures into consideration. The overlay image providing system shown in FIG. 1 comprises: an overlay image providing server 101, an upload device 102, and a download device 103.

In addition, the overlay image providing system further comprises an image pickup device 104, and the image pickup device 104 is a device having an imaging pickup function, e.g., a video camera, a digital camera, a digital video recorder, a mobile phone having a photographing function, a digital recorder, a digital photo album, etc., and integrating the functions of the upload device 102 and the download device 103.

The upload device 102 uploads the overlay image to the overlay image providing server 101 via the network, and the overlay image providing server 101 stores the uploaded overlay image and the related information thereof in a database and generates one corresponding thumbview to be browsed by the user. Certainly, the thumbview of the overlay image can be also generated by the upload device 102, and the upload device 102 uploads the thumbview of the overlay image to the overlay image providing server 101 while uploading the overlay image. The upload device 102 can be specifically a computer, various intelligent terminals such as a mobile phone, a PDA (Personal Digital Assistant), a palm computer, a notebook computer, a smart television or any device having a network connecting and displaying function, or an image pickup device such as a digital camera, a digital video recorder, a mobile phone having a photographing function, a digital recorder, a digital photo album, etc.

The download device 103 can access the overlay image providing sever 101 via the network and inquire about the desired overlay image. The image providing server 101 performs the query according to the query condition transmitted by the download device 103 and returns the query result meeting the query condition to the download device 103, and the download device 103 can select one or more overlay images from the query result to download it or them to this device. The download device 103 can be specifically a computer, various intelligent terminals such as a mobile phone, a PDA, a palm computer, a notebook computer, a smart television, a TV or any device having a network connecting and displaying function, or an image pickup device such as a digital camera, a digital video recorder, a mobile phone having a photographing function, a digital recorder, a digital photo album, etc.

The flow chart of the specific method of the upload device 102 uploading the overlay image to the overlay image providing server 101 via the network, as shown in FIG. 2, comprises the following steps:

S200: The upload device 102 acquires a URL address of the overlay image providing server 101.

The upload device 102 can acquire the network address (URL address) of the overlay image providing server 101 in multiple manners, e.g., selecting the network address of the overlay image providing server 101 from the download addresses of some overlay images stored locally beforehand, or acquiring the URL link address of the overlay image providing server 101 via some websites, or selecting the network address of the overlay image providing server 101 among the URL (Uniform Resource Locator) link addresses generated according to the download information of the overlay image.

S201: The upload device 102 accesses the overlay image providing server 101.

The upload device 102 accesses the overlay image providing server 101 via the network according to the website or program interface of the overlay image providing server 101.

Specifically, the overlay image providing server 101 can provide a service for the upload device 102 in a manner of providing a website, and the overlay image providing server 101 can also provide a service via a program running at the backstage after the upload device 102 establishes a connection with the overlay image providing server 101 rather than in a website manner.

A specific solution is stated below by taking the overlay image providing server 101 providing a service for the upload device 102 in a manner of providing a website as an example, i.e., after the upload device 102 is connected to the homepage accessing the overlay image providing server 101, the key “Uploading Overlay Image” can be clicked to enter the website of uploading the overlay image. The upload device 102 can upload the overlay image to the overlay image providing server 101 via the website of uploading the overlay image.

S201: The upload device 102 determines the overlay image to be uploaded.

Specifically, the overlay image to be uploaded inputted by the user can be received in the page of uploading the overlay image provided by the overlay image providing server 101, i.e., the user selects one image from some images, e.g., a digital photo or image which may undergo clip processing, to serve as the overlay image to be uploaded via the upload device 102.

S202: The upload device 102 receives the related information of the overlay image to be uploaded inputted by the user.

Specifically, the related information, e.g., the name of the overlay image, the label of the overlay image, the retrieval key word information of the overlay image, the category of the overlay image, the share attribute of the overlay image, the date of generation, etc., of the overlay image to be uploaded inputted by the user can be further received in the page of uploading the overlay image provided by the overlay image providing server 101.

S203: The upload device 102 uploads the overlay image to be uploaded and the related information thereof to the overlay image providing server 101.

The user determines the overlay image to be uploaded in the page of uploading the overlay image provided by the overlay image providing server 101 via the upload device 102, and the upload device 102 uploads the overlay image to be uploaded and the related information thereof to the overlay image providing server 101 by clicking a key such as “Sending” or “Submitting” after inputting the related information of the overlay image to be uploaded.

Preferably, before the upload device 102 uploads the overlay image to be uploaded and the related information thereof to the overlay image providing server 101, the user can also perform a login operation via the upload device 102, i.e., inputting the user account and password via the upload device 102 and transmitting them to the overlay image providing server 101, so the overlay image providing server 101 can confirm the identity of the user.

As a more preferable implementation mode, the upload device 102, before uploading the overlay image, can use a built-in image editing tool in the upload device 102 to edit the overlay image by clicking the button “Trimming” on the interface, e.g., setting a pixel of a specific color in the overlay image to a transparent pixel, or removing a pixel in a specific region in the overlay image or setting it to a transparent one, so that the overlay image is more convenient for use.

Another more preferably implementation mode is as follows: the user can input the edit information of the overlay image to be uploaded to the upload device 102 by clicking the button “Trimming” on the interface, and the upload device 102, when uploading the overlay image, further uploads the edit information to the overlay image providing server 101; the overlay image providing server 101 uses an editing tool at the backstage to edit the overlay image uploaded along with the edit information according to the uploaded edit information, e.g., setting a pixel of a specific color in the overlay image to a transparent pixel, or removing a pixel in a specific region in the overlay image or setting it to a transparent one, so that the overlay image is more convenient for use.

S204: The overlay image providing server 101 stores the overlay image and the related information thereof uploaded by the upload device 102.

Preferably, if the overlay image providing server 101 needs to store a large number of overlay images and the related information thereof, in order to facilitate the subsequent query, the overlay image providing server 101 can store the image file of the overlay image in an overlay image storage server, and correspondingly store the related information of the overlay image and the storage address of the overlay image in the overlay image storage server in a database. The storage address of the overlay image in the overlay image storage server can be specifically a URL link. That is to say, with respect to each overlay image, the related information of the overlay image and the storage address of the overlay image in the overlay image storage server are correspondingly stored in the database.

In addition, information such as the user account and password can be further stored in the database. For example, in the database, a data sheet is established corresponding to the respective user account, and the related information of the overlay image uploaded by an account corresponding to the data sheet, the storage address of the overlay image in the overlay image storage server and the like are stored in the data sheet.

S205: The overlay image providing server 101 generates one thumbview corresponding to the overlay image according to the overlay image uploaded by the upload device 102 to perform presentation.

The overlay image providing server 101 generates one thumbview corresponding to the overlay image according to the overlay image uploaded by the upload device 102, and the thumbview and the storage address of the related information of the overlay image in the database are correspondingly stored in the overlay image providing server 101.

For example, the overlay image providing server 101 generates one file with respect to the uploaded overlay image, the file including the thumbview corresponding to the overlay image and the storage address of the related information of the overlay image in the database. The storage address of the related information of the overlay image in the database can specifically include a data sheet name and a serial number of the overlay image in the data sheet. The related information of the overlay image can be found out according to the data sheet name and the serial number of the overlay image in the data sheet.

In addition, the overlay image providing server 101 further stores the storage address of the thumbview in the database, and associates it with the related information of the overlay image. That is to say, the storage address of the thumbview in the overlay image providing server 101 is further stored corresponding to the related information of the overlay image in the database, and the storage address of the thumbview in the overlay image providing server 101 is specifically the above storage address containing the file of the thumbview generated with respect to the uploaded overlay image. The overlay image providing server 101 presents the thumbviews of the respective uploaded overlay images on the overlay image page view. The overlay image page view contains thumbview information, and can be specifically an overlay image web page view or carriers containing thumbview information in other forms.

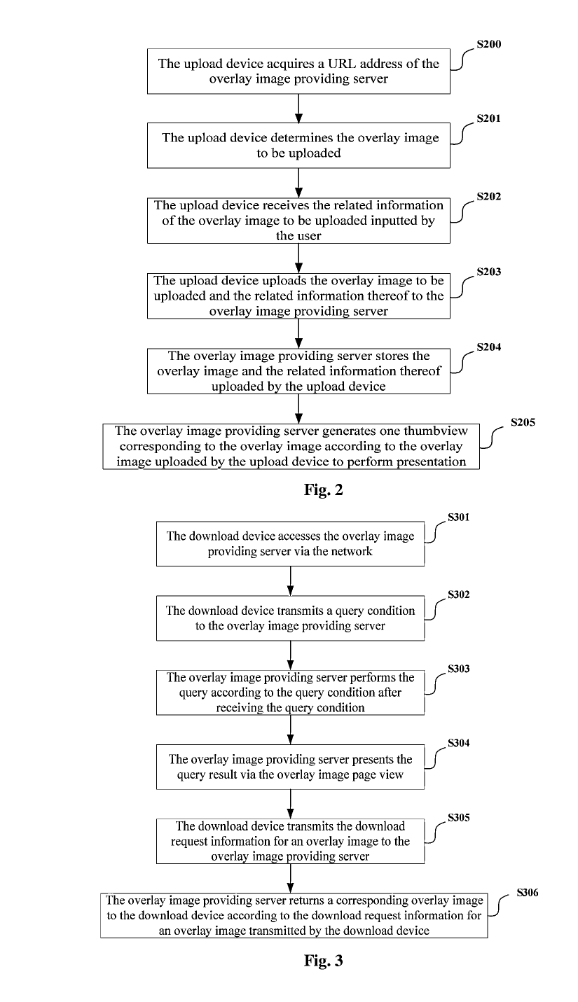

The flow chart of the method of the download device 103 acquiring the overlay image from the overlay image providing server 101 via the network, and superimposing the overlay image onto the field of view of camera, as shown in FIG. 3, comprises the following steps:

S301: The download device 103 accesses the overlay image providing server 101 via the network.

The download device 103 accesses the overlay image providing server 101 via the network according to the website or program interface of the overlay image providing server 101.

Specifically, the overlay image providing server 101 can provide a service for the download device 103 in a manner of providing a website, and the overlay image providing server 101 can also provide a service via a program running at the backstage after the download device 103 establishes a connection with the overlay image providing server 101 rather than in a website manner.

A specific solution is stated below by taking the overlay image providing server 101 providing a service for the download device 103 in a manner of providing a website as an example, i.e., the overlay image providing server 101 presents the thumbviews of the respective uploaded overlay images on the overlay image page view. The user can browse the thumbviews of the respective overlay images presented on the overlay image page view via the download device 103. In addition, a query condition input box can be also provided on the overlay image page view.

S302: The download device 103 transmits a query condition to the overlay image providing server 101.

Specifically, the user can input a query condition in a query condition input box of the overlay image page view via the download device 103. The inputted query condition, for example, can include a key word, a kind of an image, IMAGE_ID (image number), an image author, etc. The download device 103 transmits the inputted query condition to the overlay image providing server 101 by clicking the key “Searching” of the overlay image page view after inputting the query condition.

In addition, the download device 103, when transmitting the query condition, can also transmit an ordering condition, for example, an ordering condition of ordering according to time, or an ordering condition of ordering according to initials, or an ordering condition of ordering according to download traffic.

S303: The overlay image providing server 101 performs the query according to the query condition after receiving the query condition.

Specifically, the overlay image providing server 101 generates a query retrieval strategy according to the query condition to perform the seeking in the database. For example, if the query condition includes a key word “apple” and a category “PHOTO”, the overlay image providing server 101 seeks for the related information of the overlay image whose retrieval key word information includes “apple” and whose category is “PHOTO” in the related information of the overlay image in the database to serve as the related information of the overlay image meeting the query condition.

The overlay image providing server 101 fetches the thumbview according to storage address of the thumbview associated with the related information of the overlay image meeting the query condition. Namely, the storage address of the thumbview corresponding to the related information of the overlay image meeting the query condition is determined, and the thumbview is fetched according to the storage address of the determined thumbview.

S304: The overlay image providing server 101 presents the query result via the overlay image page view.

The overlay image providing server 101 presents the thumbview fetched in the step S303 as the query result in the overlay image page view transmitted to the download device 103.

In addition, if further receiving the ordering condition transmitted by the download device 103, the overlay image providing server 101, before presenting the query results in the overlay image page view transmitted to the download device 103, firstly orders the query results according to the ordering condition; then transmits the ordered query results to the overlay image page view transmitted to the download device 103 to perform presentation.

S305: The download device 103 transmits the download request information for an overlay image to the overlay image providing server 101.

Since the query result is presented in the overlay image page view transmitted to the download device 103, the user can select the overlay image to be downloaded in the overlay image page view via the download device 103, i.e., after the thumbview of the selected overlay image is clicked, the download device 103 transmits the download request information for the overlay image corresponding to the thumbview to the overlay image providing server 101.

S306: The overlay image providing server 101 returns a corresponding overlay image to the download device 103 according to the download request information for an overlay image transmitted by the download device 103.

Specifically, the overlay image providing server 101 determines the thumbview selected by the download device 103 according to the received download request information for an overlay image; the overlay image providing server 101 determines from the database the related information of the overlay image corresponding to the thumbview and the storage address of the overlay image stored corresponding to the related information of the overlay image in the overlay image storage server according to the storage address of the related information of the overlay image corresponding to the thumbview in the database; the overlay image providing server 101 fetches the overlay image and returns the overlay image to the download device according to the storage address of the determined overlay image in the overlay image storage server.

Further, the overlay image providing server can also provide API (Application Program Interface) for accessing the database for a third party, so that the third party can use the resource of the overlay images corresponding to the related information stored in the database of this server. For example, the third party can perform operations such as the query of the overlay image by fetching the API of the database.

The download device 103, after obtaining the overlay image, can directly superimpose the overlay image onto the field of view of camera to obtain a photographed image with a composition effect. The download device 103 can also perform editing after superimposing the overlay image on the other images to obtain an edited image with a composition effect.

If the download device 103 is specifically an image pickup device, the overlay image returned by the overlay image providing server 101 to the download device 103 is superimposed onto the field of view of camera of the download device 103. Specifically, after acquiring the overlay image, the download device 103 can superimpose the acquired overlay image onto the field of view of camera before performing photographing to thereby obtain a photographed or edited image with a composition effect after photographing or editing.

In fact, if the overlay image is directly superimposed onto the field of view of camera, or the overlay image is directly superimposed on the other images to obtain an image with a composition effect, the image is sometimes unnatural. So, before superimposing the overlay image onto the field of view of camera or on the other images, the user can also firstly edit the overlay image, e.g., performing editing operations such as transmission of shadow, light processing, fuzzy edge processing, color adjustment and application of filter, 3D rotation, deletion of specific pixels, special filter processing (e.g., only displaying one color, gray processing) under the overlay image real-time editing mode provided by the download device 103 or the overlay image editing module of the image pickup device, and then perform superimposition to obtain an image with a better composition effect. Specifically, the overlay image editing module receives an editing operation instruction with respect to the overlay image by the user to edit and modify the corresponding overlay image before the overlay image superimposing module superimposes the overlay image acquired by the overlay image acquiring module onto the field of view of camera.

Further, under the overlay image real-time editing mode of the overlay image editing module, the user can also set and adjust the position where the overlay image is superimposed, i.e., for example, the user can adjust the position where the overlay image is superimposed by moving the overlay image from one place to another place in the field of view of camera. The overlay image editing module can also identify different users by the face recognition technique, and provide corresponding settings of positions where a set of overlay images are superimposed for the identified user, i.e., providing the positions where a set of overlay images are superimposed previously set by the user to the user. Specifically, the overlay image editing module can also adjust the position where the overlay image is superimposed according to the user instruction before the overlay image superimposing module superimposes the overlay image acquired by the overlay image acquiring module onto the field of view of camera.

The overlay image providing server provided in the embodiment of the invention, as shown in FIG. 4, specifically comprises: an overlay image download module 401 and an overlay image upload module 402.

Wherein, the overlay image download module 401 is used for receiving download request information for an overlay image transmitted by the download device; and returning a corresponding overlay image to the download device according to the download request information for an overlay image. Specifically, the overlay image download module 401 can provide a download service of the overlay image in a website manner or provide a download service of the overlay image via a program running at the backstage. The overlay image download module 401 providing a download service of the overlay image in a website manner is taken as an example, i.e., the download request information for an overlay image is the download request information for the overlay image corresponding to the transmitted selected thumbview after the download device performs a selection among the thumbviews presented in the overlay image page view transmitted by the overlay image providing server; the overlay image providing server returns a corresponding overlay image to the download device according to the download request information for an overlay image.

The overlay image upload module 402 is used for receiving the overlay image and the related information of the overlay image uploaded by an upload device via the network and performing storage. The related information of the overlay image includes: a name, a label and a category of the overlay image. Specifically, the method of the overlay image upload module 402 performing storage after receiving the overlay image and the related information thereof uploaded by the upload device via the network is the same as the method in the above step S204, and thus is not further described in detail but described in brief as follows: the overlay image upload module 402 stores the image file of the overlay image in the overlay image storage server, and correspondingly stores the related information of the overlay image and the storage address of the overlay image in the overlay image storage server in a database; and generates a thumbview corresponding to the overlay image according to the overlay image, and correspondingly stores the thumbview and the storage address of the related information of the overlay image in the database. The overlay image upload module 402 further stores the storage address of the thumbview in the database, and associates it with the related information of the overlay image.

The overlay image upload module 402 is further used for further receiving the edit information of the overlay image when receiving the overlay image uploaded by the upload device via the network.

The overlay image providing server further comprises: an image editing module 403. The image editing module 403 edits the overlay image according to the edit information of the overlay image received by the overlay image upload module 402, i.e., setting a pixel of a specific color in the overlay image to a transparent pixel, or removing a pixel in a specific region in the overlay image or setting it to a transparent one; and transmitting the edited overlay image to the overlay image upload module 402.

The overlay image upload module 402 specifically stores the edited overlay image. That is to say, if further receiving the edit information of the overlay image when receiving the overlay image, the overlay image upload module 402 stores the edited overlay image and the related information of the overlay image without further storing the overlay image before the editing.

In addition, the overlay image download module 401 is further used for receiving a query condition transmitted by the download device, finding out the overlay image meeting the query condition according to the related information of the respective overlay images, and presenting a thumbview corresponding to the overlay image meeting the query condition in an overlay image page view transmitted to the download device as the query result before receiving the download request information for an overlay image. Specifically, the overlay image download module 401 finds outs the overlay image whose related information meets the query condition in the related information of the respective overlay images stored in the database; fetches the thumbview to present it in the overlay image page view transmitted to the download device as the query result according to storage address of the thumbview associated with the related information of the overlay image meeting the query condition.

Further, if further receiving the ordering condition transmitted by the download device, the overlay image download module 401 firstly orders the query results according to the ordering condition before transmitting the query results to the download device. Then, the query results ordered by the overlay image download module 401 are presented in the overlay image page view transmitted to the download device.

The overlay image download module 401 returning the corresponding overlay image to the download device according to the download request information for an overlay image is specifically as follows:

The overlay image download module 401 determines the thumbview selected by the download device according to the download request information for an overlay image; determines the related information of the overlay image corresponding to the thumbview and the storage address of the overlay image stored corresponding to the related information of the overlay image in the overlay image storage server according to the storage address of the related information of the overlay image corresponding to the thumbview in the database; and fetches the overlay image and returns the overlay image to the download device according to the storage address of the determined overlay image in the overlay image storage server.

Specifically, with respect to the specific working processes involved by the respective modules in the overlay image providing server of the embodiment of the invention, reference can be made to the related contents disclosed in the method of uploading and downloading the overlay image shown in FIGS. 2 and 3, and no unnecessary details are further given herein.

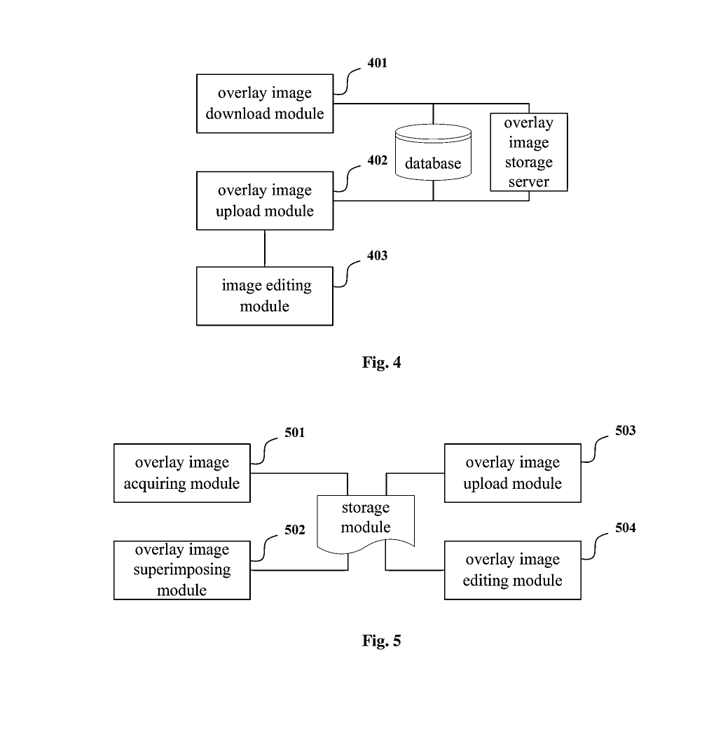

The functions of the upload device 102 can be specifically achieved in a computer or an intelligent terminal, and any device having a network connecting and displaying function. The functions of the upload device 102 can be also directly achieved in an image pickup device. The functions of the download device 103 can be specifically achieved in a computer or an intelligent terminal, and any device having a network connecting and displaying function. The functions of the download device 103 can be also directly achieved in an image pickup device. That is to say, the image pickup device provided in the embodiment of the invention can have the functions of the upload device 102 and/or the download device 103. Specifically, the image pickup device provided in the embodiment of the invention, as shown in FIG. 5, specifically comprises: an overlay image acquiring module 501 and an overlay image superimposing module 502.

The overlay image acquiring module 501 is used for transmitting download request information for an overlay image; and receiving the overlay image returned by the overlay image providing server according to the download request information after accessing the overlay image providing server via the network according to the website or program interface of the overlay image providing server. The overlay image providing sever can provide a service for the download device in a website manner or provide a service via a program running at the backstage. The overlay image providing server providing the download service of the overlay image in a website manner is taken as an example, i.e., after selecting one thumbview from the overlay image page view transmitted by the overlay image providing server, the overlay image acquiring module 501 transmits the download request information for the overlay image corresponding to the thumbview; and receives the overlay image returned by the overlay image providing server according to the download request information.

The overlay image acquiring module 501 is further used for transmitting the query condition to the overlay image providing server; and receiving the overlay image page view where the overlay image providing server presents the query result before selecting one thumbview from the overlay image page view transmitted by the overlay image providing server. The overlay image acquiring module 501 can store the overlay image in the storage module after receiving the overlay image. The overlay image in the storage module can be directly superimposed onto the field of view of camera.

The overlay image superimposing module 502 is used for superimposing the overlay image acquired by the overlay image acquiring module onto the field of view of camera. Specifically, the overlay image superimposing module 502 fetches the overlay image from the storage module and superimposes it onto the field of view of camera. After the overlay image superimposing module 502 fetches the overlay image from the storage module and superimposes it onto the field of view of camera, the image pickup device performs the photographing to thereby obtain a photographed image with a composition effect.

The image pickup device provided in the embodiment of the invention can further comprise: an overlay image upload module 503.

The overlay image upload module 503 is used for accessing the overlay image providing server via the network, and uploading the overlay image to be uploaded and the related information thereof to the overlay image providing server. The overlay image providing server can provide an upload service in a website manner or provide an upload service via a program running at the backstage. The method of the overlay image upload module 503 uploading the overlay image is the same as that introduced in the above steps S201-S203, and thus is not described in detail herein, and the process of uploading the overlay image in a website manner is described in brief as follows: the overlay image upload module 503 accesses the overlay image providing server via the network, and after selecting the overlay image to be uploaded from the storage module and after inputting the related information of the overlay image to be uploaded in the website of uploading the overlay image transmitted by the overlay image providing server, the overlay image upload module 503 uploads the overlay image to be uploaded and the related information thereof to the overlay image providing server via the website of uploading the overlay image.

In addition, the image pickup device can further comprise: an overlay image editing module 504. The overlay image editing module 504 is used for editing the overlay image before the overlay image upload module 503 uploads the overlay image, i.e., setting a pixel of a specific color in the overlay image to a transparent pixel, or removing a pixel in a specific region in the overlay image or setting it to a transparent one. The overlay image editing module 504 stores the edited overlay image in the storage module, and the overlay image upload module 503 can select the edited overlay image from the storage module to perform upload.

Or, the overlay image upload module 503 uploads the edit information of the overlay image to be uploaded to the overlay image providing server when uploading the overlay image, so the overlay image providing server can edit the overlay image according to the edit information.

An overlay image upload device provided in the embodiment of the invention can comprise the overlay image upload module 503, and then can further comprise the overlay image editing module 504.

An overlay image download device provided in the embodiment of the invention can comprise the overlay image acquiring module 501, and then can further comprise the overlay image superimposing module 502.

Specifically, with respect to the specific working processes involved by the respective modules in the image pickup device, the overlay image upload device and the overlay image download device of the embodiment of the invention, reference can be made to the related contents disclosed in the method of uploading and downloading the overlay image shown in FIGS. 2 and 3, and no unnecessary details are further given herein.

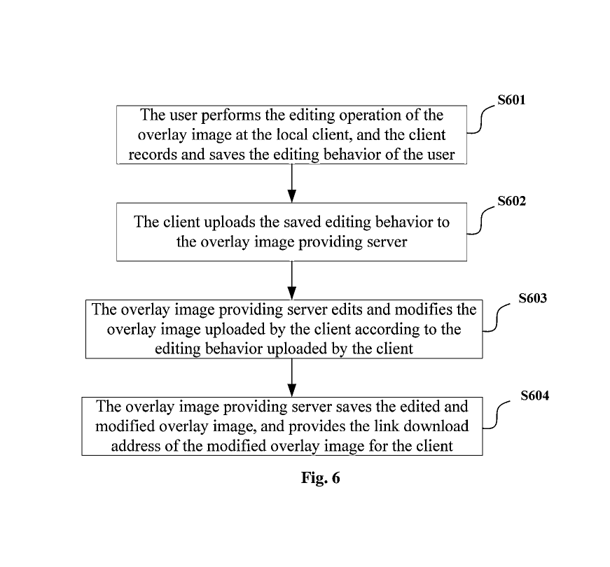

As a more preferable implementation mode, the overlay image providing server can also provide an editing function of the overlay image for a client (the client can be specifically the above upload device) accessing the server, i.e., the user can perform an editing operation of the overlay image at the local client, and the editing and modification of the overlay image are achieved by the overlay image providing server. The specific flow, as shown in FIG. 6, includes the following operating steps:

S601: The user performs the editing operation of the overlay image at the local client, and the client records and saves the editing behavior of the user.

Specifically, when the user performs the editing operation of the overlay image at the local client, the client can record the editing behavior of the user in an editing behavior list; the recorded editing behavior can include various editing operations of the overlay image by the user, e.g., trimming, adding a frame, adjusting brightness, adding a watermark, etc., and related parameters. For example, the upload device which serves as the client records and stores the editing behavior of the overlay image by the user in the editing behavior list.

S602: The client uploads the saved editing behavior to the overlay image providing server.

Specifically, the client uploads the editing behavior list which records the editing behavior to the overlay image providing server. For example, the upload device which serves as the client uploads the editing behavior saved in the editing behavior list to the overlay image providing server.

S603: The overlay image providing server edits and modifies the overlay image uploaded by the client according to the editing behavior uploaded by the client.

Specifically, the client determines one of the overlay images uploaded to the overlay image providing server as the overlay image to be edited, and the overlay image providing server edits and modifies the overlay image to be edited according to the various editing behaviors recorded in the editing behavior list uploaded by the client. For example, the overlay image providing server edits and modifies the overlay image according to the editing behavior in the editing behavior list uploaded by the upload device.

As a more preferable implementation mode, the client determines a video frame uploaded to the overlay image providing server as the video frame to be edited, and the overlay image providing server edits and modifies each image in the video frame to be edited according to the various editing behaviors recorded in the editing behavior list uploaded by the client. That is to say, each image in the video frame to be edited is uploaded to the overlay image providing server as the overlay image to be edited and modified, i.e., the overlay image uploaded by the client (including the upload device) to the overlay image providing server can be specifically each frame image in the video frame uploaded by the client (including the upload device) to the overlay image providing server.

S604: The overlay image providing server saves the edited and modified overlay image, and provides the link download address of the modified overlay image for the client.

The client can acquire the modified overlay image according to the link download address provided by the overlay image providing server. For example, after saving the edited and modified overlay image, the overlay mage providing server returns the link download address of the modified overlay image to the upload device which serves as the client.

As a more preferable implementation mode, the overlay image providing server provides the link download address for the modified video frame after editing and modifying each image in the video frame to be edited according to the various editing behaviors recorded in the editing behavior list uploaded by the client. Thus, the user can provide the video frame uploaded by the server in real time for the overlay image, the overlay image providing server edits and modifies in real time the uploaded video frame according to the various editing behaviors recorded in the editing behavior list uploaded by the client, and the user can download in real time the edited and modified video frame from the client according to the link download address.

The advantages of such editing manner are as follows: the hardware performance of the client (e.g., the camera in the upload device 102) is generally comparatively bad, for example, the resolution of the screen may be comparatively low, or the processing capacity of the processor is comparatively weak, and if the user directly edits a high precision image (e.g., an image having a comparatively high resolution) at the client, the precision of the edited image will be reduced, while in the solution provided in the invention, the user can perform the editing operation using the screen of the client, the editing behavior of the user will be recorded by the client and uploaded to the overlay image providing server 101, and the overlay image providing sever 101 edits and modifies the image according to the uploaded editing behavior, which provides convenience for editing the image for the user (the user can use the upload device 102 to perform the editing operation) and meanwhile provides a high quality image editing effect by the overlay image providing server 101.

In addition, the above overlay image providing server can also provide an overlay image recommending function for the client accessing this server, i.e., when the user accesses the overlay image providing server and browses the overlay image, an overlay image recommending module in the overlay image providing server will preferentially recommend some overlay images to be displayed in the overlay image page view; generally speaking, the overlay image recommending module will collect and count the past searching and browsing behaviors of the user and perform an analysis to obtain the preference of the overlay image by the user by analyzing, and recommend the related overlay image according to the analysis result. For example, when accessing the overlay image to be downloaded by the overlay image providing server via the download device, the user firstly opens the overlay image page view of the overlay image providing server before transmitting the query condition; the overlay image providing server recommends an overlay image to be displayed to the user in the overlay image page view, and the overlay image recommended to be displayed is preferentially recommended according to an analysis result after the overlay image providing server collects and counts past searching and browsing behaviors of the user.

The overlay image recommending module can recommend a related overlay image to the user by adopting a recommending method based on content feature extraction, or recommend a related overlay image to the user by adopting a recommending method of collaborative filtering.

The basic principle of the recommending method based on content feature extraction is as follows: performing content feature extraction of the overlay image and generating a content feature vector of each overlay image; generating the content feature vector of the overlay image of the user's interest after analyzing the past searching and browsing behaviors of the user; performing a similarity calculation of the content feature vector of the overlay image of the user's interest and the content feature vectors of the various overlay images in the overlay image providing server, and recommending the overlay image having a high similarity to the user to achieve the object of recommending the overlay image of the user's interest to the user.

The basic principle of the recommending method of collaborative filtering is as follows: performing a collaborative filtering analysis of the overlay image of the user's interest, finding (interested) users similar to the specified user in the user group, and summarizing the overlay images of the interest of these similar users to perform a recommendation to the specified user.

Since the recommending method based on content feature extraction and the recommending method of collaborative filtering are prior arts and are techniques known very well by those skilled in the art, no unnecessary details are further given herein.

Preferably, in order to save calculating and analyzing resources of the system, the overlay image providing server can also adopt a simple overlay image recommending module. The simple overlay image recommending module orders frequencies by which the respective overlay images in the overlay image providing server are accessed, and recommends the overlay images according to the ordering result, i.e., the overlay image having a high accessing heat will be preferentially recommended.

Further, the overlay image providing server can further comprise an overlay image converting module, and the overlay image converting module provides a function of converting a common image into an overlay image, i.e., in an overlay image conversion page provided by the overlay image converting module of the overlay image providing server, the user can input a website or use other search engines (e.g., Google and Baidu) to open a common image from the internet, and identify it as an image to be converted. The overlay image converting module of the overlay image providing server can convert the image to be converted identified by the user into an overlay image at the backstage; preferably, with respect to the image to be converted, the user can also invite other users to cast a vote therefore; the overlay image converting module of the overlay image providing server can convert the image to be converted for which the votes exceed a set value into an overlay image.

Further, the upload device 102, the download device 103, and the image pickup device having the functions of the upload device 102 and/or the download device 103 can further comprise an overlay image voice searching module, and the overlay image voice searching module has a function of voice searching the overlay image, i.e., receiving the search key word/term inputted by the user in a voice manner, seeking for the overlay image whose related information meets the search key word/term according to the inputted search key word/term, and displaying the overlay image as the search result. The related information of the overlay image can include: the name of the overlay image, the label of the overlay image, the retrieval key word information of the overlay image, the category of the overlay image, the share attribute of the overlay image, the date of generation, etc.

In the embodiments of the invention, since the overlay image providing server can provide an overlay image to be directly downloaded by an image pickup device, the image pickup device can directly acquire the overlay image via the overlay image providing server before superimposing the overlay image onto the field of view of camera, and seeking, processing and editing of the overlay image are omitted, which greatly simplifies the process of the image pickup device acquiring the overlay image and superimposing the overlay image onto the field of view of camera, and provides great convenience for a user. And, other users can also upload overlay images to the overlay image providing server via the upload device to provide more overlay images for the overlay image providing server to thereby achieve sharing of the overlay images.

In addition, the overlay image providing server can also provide an editing function of the overlay image, and when the upload device uploads the overlay image, the overlay image providing server can also provide an editing service of the overlay image to further facilitate the sharing of the overlay image.

Those skilled in the art can understand that all of or part of the steps for achieving the above methods of the embodiments can be achieved by instructing related hardware by a program, and this program can be stored in a computer readable storage medium, e.g., ROM/RAM, a magnetic disc, an optical disc, etc.

The above contents are only preferred implementation modes of the invention. It should be noted that those skilled in the art can also make some improvements and decorations in the case of not breaking away from the principle of the invention, and these improvements and decorations should also be deemed to be within the scope of protection of the invention.

What is claimed is:

1. An overlay image providing method, comprising:
an overlay image providing server receiving download request information for an overlay image transmitted by a download device;
the overlay image providing server returning a corresponding overlay image to the download device according to the download request information for an overlay image, wherein the overlay image is uploaded beforehand by an upload device to the overlay image providing server via the network.

2. The method according to claim 1, after the overlay image providing server returns the corresponding overlay image to the download device according to the download request information for an overlay image, further comprising:
after receiving the returned overlay image, the download device superimposing the overlay image on other images to perform editing to obtain an edited image with a composition effect; or
the download device being specifically an image pickup device, and after receiving the returned overlay image, the image pickup device performing photographing after superimposing the overlay image onto the field of view of camera to obtain an photographed image with a composition effect.

3. The method according to claim 2, before the upload device uploads the overlay image to the overlay image providing server via the network, further comprising:
the upload device editing the overlay image via a built-in image editing tool, i.e., setting a pixel of a specific color in the overlay image to a transparent pixel, or removing a pixel in a specific region in the overlay image or setting it to a transparent one.

4. The method according to claim 2, when the upload device uploads the overlay image to the overlay image providing server via the network, further comprising:
the upload device further uploading edit information of the overlay image to the overlay image providing server via the network;
after receiving the overlay image and the edit information thereof, the overlay image providing server editing the overlay image according to the edit information, i.e., setting a pixel of a specific color in the overlay image to a transparent pixel, or removing a pixel in a specific region in the overlay image or setting it to a transparent one.

5. The method according to claim 2, before the upload device uploads the overlay image to the overlay image providing server via the network, further comprising:
the upload device recording an editing behavior of the overlay image by the user and saving it in an editing behavior list; and uploading the editing behavior saved in the editing behavior list to the overlay image providing server; and
after the upload device uploads the overlay image to the overlay image providing server via the network, further comprising:
the overlay image providing server editing and modifying the overlay image according to the editing behavior in the editing behavior list uploaded by the upload device; and saving the edited and modified overlay image, and returning a link download address of the modified overlay image to the upload device.

6. The method according to claim 1, further comprising: when uploading the overlay image to the overlay image providing server via the network, the upload device further uploading related information of the overlay image to the overlay image providing server, the related information of the overlay image including: a name, a label and a category of the overlay image.

7. The method according to claim 6, before the overlay image providing sever receives the download request information for an overlay image, further comprising
the overlay image providing server receiving a query condition transmitted by the download device, finding out the overlay image meeting the query condition according to the related information of the respective overlay images, and presenting a thumbview corresponding to the overlay image meeting the query condition in an overlay image page view transmitted to the download device.

8. The method according to claim 7, before the overlay image providing server receives the query condition transmitted by the download device, further comprising:
the overlay image providing server recommending an overlay image to be displayed to a user in the overlay image page view, and the overlay image recommended to be displayed being preferentially recommended according to an analysis result after the overlay image providing server collects and counts past searching and browsing behaviors of the user or searching and browsing behaviors of a user similar to this user to perform an analysis;
or the overlay image providing server recommending an overlay image to be displayed to a user in the overlay image page view, and the overlay image recommended to be displayed being preferentially recommended according to an ordering result after the overlay image providing server orders frequencies by which the respective overlay images are accessed, or orders times by which the respective images are accessed, or numbers of times by which the respective overlay images are accessed.

9. The method according to claim 7, after the upload device uploads the overlay image and the related information thereof to the overlay image providing server via the network, further comprising:
the overlay image providing server storing an image file of the overlay image in an image storage server, and correspondingly storing the related information of the overlay image and the storage address of the overlay image in the overlay image storage server in a database; the overlay image providing server generating a thumbview corresponding to the overlay image according to the overlay image, and correspondingly storing the thumbview and the storage address of the related information of the overlay image in the database;
the overlay image providing server further storing the storage address of the thumbview in the database, and associating it with the related information of the overlay image.

10. The method according to claim 9, the finding out the overlay image meeting the query condition according to the related information of the respective overlay images, and presenting a thumbview corresponding to the overlay image meeting the query condition in an overlay image page view transmitted to the download device being specifically as follows:
finding out the overlay image whose related information meets the query condition in the related information of the respective overlay images stored in the database;
fetching the thumbview to present it in the overlay image page view transmitted to the download device according to the storage address of the thumbview associated with the related information of the overlay image meeting the query condition.

11. The method according to claim 10, the overlay image providing server returning a corresponding overlay image to the download device according to the download request information for an overlay image specifically comprising:
the overlay image providing server determining the thumbview selected by the download device according to the download request information for an overlay image;
determining the related information of the overlay image corresponding to the thumbview and the storage address of the overlay image stored corresponding to the related information of the overlay image in the overlay image storage server according to the storage address of the related information of the overlay image corresponding to the thumbview in the database;
fetching the overlay image and returning the overlay image to the download device according to the storage address of the determined overlay image in the overlay image storage server.

12. The method according to claim 7, characterized in that when receiving the query condition transmitted by the download device, the overlay image providing server further receives an ordering condition transmitted by the download device; and
before presenting the thumbview corresponding to the overlay image meeting the query condition in the overlay image page view transmitted to the download device as a query result, the method further comprises:
ordering the query results according to the ordering condition.

13. The method according to claim 1, before the overlay image providing server receives the download request information for an overlay image transmitted by the download device, and the overlay image providing server returns the corresponding overlay image to the download device according to the download request information for an overlay image, further comprising:
the overlay image being converted from a common image, i.e., in an overlay image conversion page provided by the overlay image providing server, a user inputs a website or uses other search engines to open a common image from the internet, and identifies it as an image to be converted, and after inviting other users to cast a vote therefor, the overlay image providing server converts the image to be converted for which the votes exceed a set value into an overlay image.

14. An overlay image providing server, comprising:
an overlay image download module for receiving download request information for an overlay image transmitted by a download device; and returning a corresponding overlay image to the download device according to the download request information for an overlay image;
an overlay image upload module for receiving and storing the overlay image uploaded by an upload device via the network.

15. The server according to claim 14, characterized in that
the overlay image upload module is further used for further receiving related information of the overlay image uploaded by the upload device when receiving the overlay image uploaded by the upload device via the network, the related information of the overlay image including: a name, a label and a category of the overlay image.

16. The server according to claim 15, characterized in that
the overlay image upload module is further used for further receiving edit information of the overlay image when receiving the overlay image; and the server further comprises:
an image editing module for editing the overlay image according to the edit information of the overlay image, i.e., setting a pixel of a specific color in the overlay image to a transparent pixel, or removing a pixel in a specific region in the overlay image or setting it to a transparent one; and transmitting the edited overlay image to the overlay image upload module; and
the overlay image upload module specifically stores the edited overlay image.

17. The server according to claim 16, characterized in that
the overlay image download module is further used for receiving a query condition transmitted by the download device, finding out the overlay image meeting the query condition according to the related information of the respective overlay images, and presenting a thumbview corresponding to the overlay image meeting the query condition in an overlay image page view transmitted to the download device before receiving the download request information for an overlay image.

18. The server according to claim 17, characterized in that
the overlay image upload module is further used for storing an image file of the overlay image in an image storage server, and correspondingly storing the related information of the overlay image and the storage address of the overlay image in the overlay image storage server in a database; and generating a thumbview corresponding to the overlay image according to the overlay image, and correspondingly storing the thumbview and the storage address of the related information of the overlay image in the database after receiving the overlay image and the related information thereof uploaded by the upload device via the network.

19. The sever according to claim 18, characterized in that
the overlay image download module finding out the overlay image meeting the query condition according to the related information of the respective overlay images, and presenting a thumbview corresponding to the overlay image meeting the query condition in an overlay image page view transmitted to the download device is specifically as follows:
the overlay image download module finds out the overlay image whose related information meets the query condition in the related information of the respective overlay images stored in the database; and fetches the thumbview to present it in the overlay image page view transmitted to the download device according to storage address of the thumbview associated with the related information of the overlay image meeting the query condition.

20. An image pickup device, comprising:
an overlay image acquiring module for transmitting download request information for an overlay image; and receiving the overlay image returned by the overlay image providing server according to the download request information after accessing the overlay image providing server via the network;
an overlay image superimposing module for superimposing the overlay image acquired by the overlay image acquiring module onto the field of view of camera.

21. The device according to claim 20, characterized in that the overlay image acquiring module transmitting download request information for an overlay image after accessing the overlay image providing server via the network is specifically as follows:
after accessing the overlay image providing server via the network, the overlay image acquiring module selects one thumbview from an overlay image page view transmitted by the overlay image providing server, and then transmits the download request information for the overlay image corresponding to the thumbview.

22. The device according to claim 21, characterized in that
the overlay image acquiring module is further used for transmitting the query condition to the overlay image providing server and receiving the overlay image page view where the overlay image providing server presents the query result, before selecting one thumbview from an overlay image page view transmitted by the overlay image providing server.
